(19) United States
(12) Patent Application Publication
(10) Pub. No.: US 2008/0076362 A1
(43) Pub. Date: Mar. 27, 2008

(54) PTT system, method for implementing PTT communication, PTT management server and terminal device thereof

(75) Inventor: Rihui Tian, Beijing (CN)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Lenovo (Beijing) Limited, Beijing (CN)

(21) Appl. No.: 11/900,947

(22) Filed: Sep. 14, 2007

(30) Foreign Application Priority Data
Sep. 14, 2006 (CN) 200610153891.X

(51) Int. Cl. H04B 1/38

(52) U.S. Cl. 455/90.2

(57) ABSTRACT

A PTT system comprises a plurality of terminal devices and a PTT management server interacting via a connection network. The PTT management server is configured to set up a unicast connection between the PTT management server and a source terminal device and a multicast connection between the PTT management server and a destination terminal device according to a call request from the source terminal device; and to receive an uplink media stream and transmit a downlink media stream. The unicast connection is used for transmission of the uplink media stream from the source terminal device to the PTT management server, and the multicast connection is used for transmission of the downlink media stream from the PTT management server to the destination terminal device. The present invention can implement PTT transmission of audio, image, data, etc. with a simple network structure.

### BACKGROUND OF THE INVENTION

1. Field of Invention

The present invention relates to a technique of Push to Talk (PTT), and more particularly a technique of implementing PTT by using enterprise intranet.

2. Description of Prior Art

PTT means to use a mobile phone with a corresponding function as a walkie-talkie, which is a half-duplex manner of communication. Such a mobile phone has a talk key, and a user may communicate with other users or a group when it is pressed (wherever far or near, it only needs that they are within a coverage of an operator's network). Simply speaking, PTT is a mobile phone with a “push to talk” function, which combines the function of mobile phone with that of walkie-talkie, thereby to implement PTT with the existing mobile communication network.

The PTT mobile phone is different from the general walkie-talkie. Firstly, the walkie-talkie doesn't need to work via the network, while PoC (Push-To-Talk over Cellular) communicates via the mobile communication network, whose communication range is not limited to several kilometers any more. Wherever it is covered by signals from the mobile communication network, a communicating party can make a PTT communication. Secondly, as compared with the general walkie-talkie communicating by power transmission in a short range, POC service has strong advantages including roaming-capable.

Various of PTT solutions have been disclosed in prior art, such as in a Chinese patent application CN200410009054.0 entitled “PTT service system and method for implementing the service”. In the patent application, it mentions that WiFi can be used in a wireless access network in its PTT solution, whose core scheme of networking comprises a user terminal device, an application server, a control device and a gateway device based on a wired or wireless switching access network.

However, the existing PTT techniques have problems of the following aspects:

1. The existing commercialized PTT systems are all based on a cellular network, i.e. “Push-To-Talk over Cellular” (POC). That is to say, the terminal device must use a network of a mobile operator, and POC service is separately charged for. The caused fee is a great pressure for a clustering communication in an enterprise. As mentioned above, the overall scheme of PTT implementation is also based on IP Multimedia Subsystem (IMS);

2. The existing PTT (or PoC) solutions can only provide audio communication and can not provide video and data communication;

3. The existing PTT (or PoC) solutions are too complicated, and are not suitable for deployment and implementation in an enterprise;

4. The existing PTT (or PoC) solutions haven't applied to a fixed terminal.

### SUMMARY OF THE INVENTION

To solve the problems in the solutions for the existing PTT system, an object of the present invention is to provide a PTT system, a method for implementing PTT communication, a PTT management server and a terminal device, which can implement PTT transmission of audio, image, data, etc. with a simple network structure.

To achieve the above object, the present invention provides a PTT system, comprising a terminal device and a PTT management server interacting via a connection network, wherein

the PTT management server is configured to set up a unicast connection between the PTT management server and a source terminal device and a multicast connection between the PTT management server and a destination terminal device according to a call request from the source terminal device; and to receive an uplink media stream and transmit a downlink media stream;

the unicast connection is used for transmission of the uplink media stream from the source terminal device to the PTT management server, and the multicast connection is used for transmission of the downlink media stream from the PTT management server to the destination terminal device.

In the system as described above, the PTT management server comprises in detail:

a user group and presence management module configured to setup and manage a user group, to obtain and record an presence information of the terminal device, and to provide information of the user group and the presence information of the terminal device;

a call management module configured to set up the unicast connection according to the call request from the source terminal device;

a multicast management module configured to set up the multicast connection according to the information of the user group and the presence information of the terminal device;

a media stream forwarding module configured to receive the uplink media stream from the unicast connection, and to transmit the received uplink media stream to the online destination terminal device via the multicast connection.

In the system as described above, the terminal device comprises in detail:

an access module configured to access to a connection network via a wireless network;

a PTT initiation module configured to connect with a call control module;

the call control module configured to transmit a call request to the PTT management server, and to inform a media stream processing module to process the media stream after receiving a message on success of call request establishment;

the media stream processing module configured to obtain the uplink media stream, and to transmit it to the PTT management server via the unicast connection and to receive the downlink media stream via the multicast connection.

In the system as described above, the uplink media stream and the downlink media stream are media stream for audio and/or video and/or data.

In the system as described above, the connection network is WiFi, Wimax or UWB network, or 3G, B3G wireless network.

To better achieve the object as described above, the present invention also provides a method for PTT communication implementation by the PTT system, which comprises:

Step S1 in which a user transmits a call request to a PTT management server via a terminal device;

Step S2 in which the PTT management server sets up a unicast connection between the PTT management server and a source terminal device and a multicast connection between the PTT management server and a destination terminal device according to a call request from the source terminal device;

Step S3 in which the source terminal device transmits the uplink media stream to the PTT management server via a unicast connection;

Step S4 in which the PTT management server transmits the received uplink media stream to the destination terminal device via the multicast connection.

In the method as described above, Step S2 comprises in detail:

Step S21 in which the PTT management server obtains information of the user group in which the terminal device initiating the call request is located, after receiving the call request;

Step S22 in which the PTT management server judges whether or not there is a user being sending information or speaking in the user group; If yes, it returns to the terminal device a message on failure of call request establishment, and terminates the process; otherwise, it returns to the terminal device a message on success of call request establishment, and proceeds to Step 23;

Step 23 in which the PTT management server sets up the unicast connection between the PTT management server and the source terminal device and the multicast connection between the PTT management server and the destination terminal device.

In the method as described above, it further comprises:

Step S5 in which the source terminal device transmits to the PTT management server a call termination request message, and after its status is updated by the PTT management server, PTT management server removes the unicast connection and the multicast connection and the PTT communication is terminated.

In the method as described above, it further comprises:

Step S6 in which the destination terminal device decodes the received downlink media stream and presents it to a user.

In the method as described above, the uplink media stream is a media stream for audio and/or video and/or data.

To better achieve the object as described above, the present invention also provides the PTT management server, which comprises:

a user group and presence management module configured to setup and manage a user group, to obtain and record an presence information of the terminal device, and to provide information of the user group and the presence information of the terminal device;

a call management module configured to set up a unicast connection according to a call request from the source terminal device;

a multicast management module configured to set up a multicast connection according to the information of the user group and the presence information of the terminal device;

a media stream forwarding module configured to receive an uplink media stream from the unicast connection, and to transmit the received uplink media stream to the online destination terminal device via the multicast connection.

In the PTT management server as described above, the uplink media stream is a media stream for audio and/or video and/or data.

To better achieve the object as described above, the present invention also provides a terminal device, which comprises:

An access module configured to access a connection network via a wireless network;

a PTT initiation module configured to connect with the call control module;

the call control module configured to transmit a call request to the PTT management server, and to inform a media stream processing module to process the media stream after receiving a message on success of call request establishment;

the media stream processing module configured to obtain an uplink media stream, and transmit it to the PTT management server via the unicast connection and to receive a downlink media stream via the multicast connection.

In the terminal device as described above, the uplink media stream is a media stream for audio and/or video and/or data.

The present invention has beneficial effects as follows:

it may be used in a fixed terminal;

The networking is very simple, since it only needs a server to implement the PTT networking of the whole corporation;

The PTT is implemented via WiFi/WiMAX or Intranet within an enterprise, without need of a POC service provided by an operator, which can reduce cost greatly while ensuring the user experience.

The effect of the PTT on bandwidth is minimized by utilizing a multicast technique for improving transmission efficiency of the PTT;

The network bandwidth within an enterprise is much higher than that of a cellular network, which can achieve better quality of audio and to provide PTT service for video and data simultaneously.

### BRIEF DESCRIPTION OF THE DRAWINGS

FIG. 1 is a structure diagram of a PTT system according to the present invention;

FIG. 2 is a structure diagram of a terminal device according to the present invention;

FIG. 3 is a structure diagram of a PTT management server according to the present invention; and

FIG. 4 is a structure diagram of implementing PTT communication by a PTT system according to the present invention.

### DETAILED DESCRIPTION OF PREFERRED EMBODIMENTS

Before the present invention is explained in detail, some basic conceptions involved in the present invention are explained in order to better describe the detail implementation of the present invention.

A call is a multimedia communication process initiated by one terminal device and participated in by a plurality of terminal devices. In each call process, only one terminal device can send information, and other terminal devices receive information.

A terminal device transmitting a call is a source terminal device and a terminal device receiving a call is a destination terminal device.

A user group consists of all the terminal devices participating in the call, including at least one of source terminal devices and one or more destination terminal devices.

A media stream is a set of data stream in the form of audio and/or video and/or data transmitted in the call;

An uplink media stream is a media stream transmitted from the source terminal device to the PTT management server;

A downlink media stream is a media stream transmitted from the PTT management server to the destination terminal device;

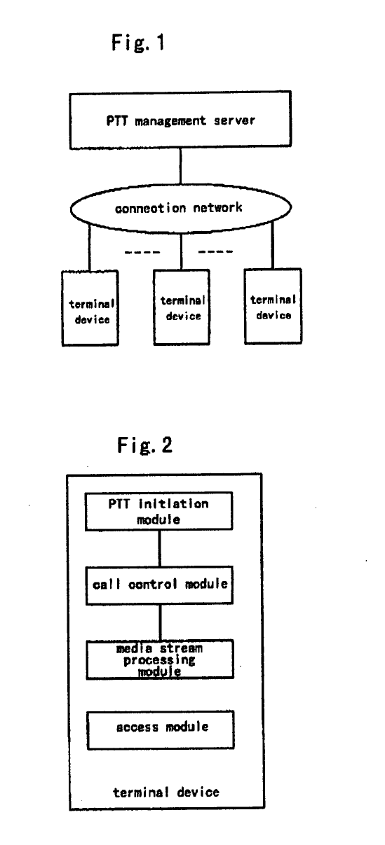

The PTT system according to the present invention implements PTT in the wireless enterprise network by using a multicast technique, which comprises the terminal device, the PTT management server and a connection network as shown in FIG. 1.

The terminal device comprises a mobile terminal device (such as a personal digital assistant (PDA), a smart mobile phone or a multi-mode mobile phone etc.) and/or a fixed terminal device. The mobile terminal device accesses to the connection network via WiFi, WiMax or Ultra Wideband (UWB), 3G, b3G Wireless network etc., and the fixed terminal device accesses to the connection network in a wired manner.

The PTT management server has a function of multicast management, and is used to store, manage a user group and presence information of related users in the group, and to establish a multicast network, set up a call, realize transmission of a signaling stream and a media stream between the terminal devices based on the group of the users.

The connection network is used to connect the PTT management server with the terminal device. Herein, the connection network is a wireless access network (such as WiFi, WiMax or Ultra Wideband (UWB), 3G, b3G Wireless network etc.) or a wired network (such as Ethernet) constituting an enterprise Intranet.

Hereinafter, the PTT management server, the terminal device etc. according to the present invention will be further explained in detail with reference to the drawings.

As shown in FIG. 2, the terminal device according to the present invention comprises an access module, a PTT initiation module, a call control module and a media stream processing module.

The access module accesses to the connection network. When it is a mobile terminal device, the terminal device accesses to the connection network via WiFi, WiMax or Ultra Wideband (UWB), 3G, b3G Wireless network, etc. When it is a fixed terminal device, the terminal device accesses to the connection network in a wired manner.

The PTT initiation module is connected with the call control module.

The call control module is used to receive a instruction for initiating PTT communication, which is sent by a user through the PTT initiation module; to transmit a call request to the PTT management server after receiving the instruction; and to inform the media stream processing module to perform a media stream processing after receiving a message of success of call request establishment.

The media stream processing module is used to encode the audio and/or video and/or data into a media stream, to transmit it to the PTT management server via a unicast connection, to receive the encoded audio and/or video and/or data media stream via a multicast connection, and to decode the encoded media stream.

The PTT initiation module may be keys arranged in the terminal device, shortcut keys, or software icons or menu options arranged in the terminal device.

The call control module is a module based on H.323 or SIP client.

In the media stream processing module, signals are collected from audio or video input of the terminal device, and A/D converted into digital signals which are then combined into a media stream. Files in the file system of the terminal device can also be combined into the media stream.

Conversion of the audio signal into the digital signal may cover various audio compression algorithms such as G.273, G.729, AMR, etc.

Conversion of the video signal into the digital signal may cover various video compression algorithms such as MPEG family, VC1, Real, etc.

The combination of audio and/or video and/or data supports protocols such as RTP/RTCP etc.

The received media stream is decoded in terms of audio, video, and data, and is D/A converted into an analog signal as needed. Audio output (speaker or earphone) or video output (display screen) is performed on the terminal device. Files in the media stream are written into the file system of the terminal.

For decoding the audio signal, various of audio compression algorithms such as G.273, G.729, AMR etc can be used.

For decoding the video signal, various of video compression algorithms such as MPEG family, VC1, Real etc can be used.

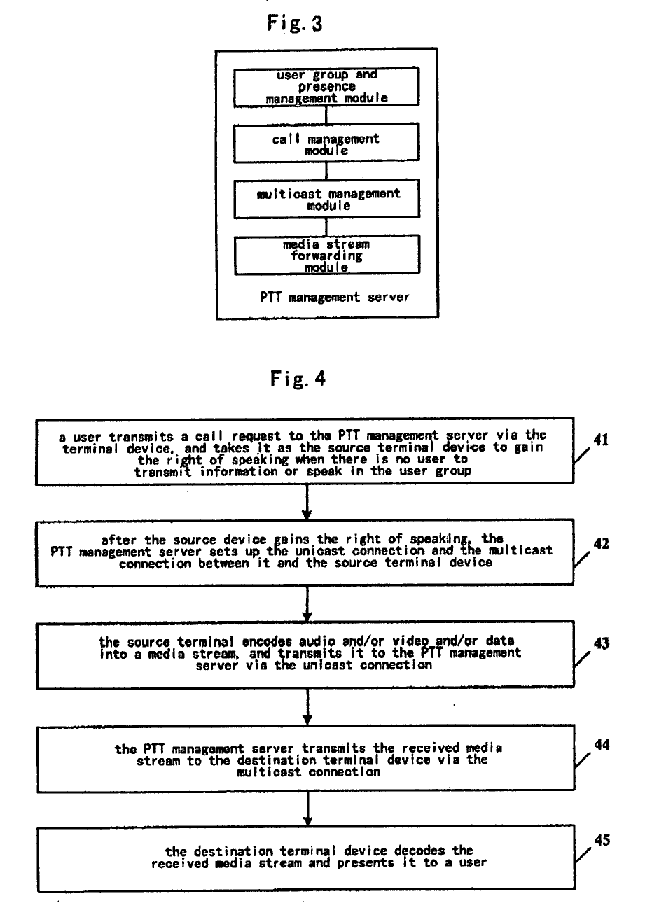

As shown in FIG. 3, the PTT management server according to the present invention comprises a user group and presence management module, a call management module, a multicast management module and a media stream forwarding module.

The user group and presence management module is configured to setup and manage the user group based on configuration information from the user or administrator, to obtain and record the presence information of the terminal device, and to provide information of the user group and a presence information of the terminal device.

The call management module is configured to receive a call request issued from the source terminal device, to set up the unicast connection, which is used for transmission of an uplink media stream from the source terminal device to the PTT management server.

The multicast management module is configured to set up a multicast connection according to the information of the user group and the presence information of the terminal device. The multicast connection is used for transmission of a downlink media stream from the PTT management server to the online destination terminal device.

The media stream forwarding module is configured to receive uplink media stream from the unicast connection, and to transmit the received uplink media stream to the online destination terminal device via the multicast connection.

The call management module is implemented by using a H.323 gatekeeper, a SIP server or an application server platform.

The multicast management module sets up the multicast connection by using multicast protocols such as IGRP, PIM, DVMRP etc.

The media stream forwarding module supports protocols such as RTP/RTCP, and includes a media stream control module which is configured for stream control according to the level of QoS.

The method for PTT communication implementation by the PTT system according to the present invention is shown in FIG. 4, which comprises the following steps.

At Step 41, in a user group, a user transmits a call request to the PTT management server via the terminal device, and takes it as the source terminal device to gain the right of speaking when there is no user to transmit information or to speak in the user group.

At Step 42, after the source terminal device gains the right of speaking, the PTT management server sets up a unicast connection with the source terminal device and a multicast connection with the destination terminal device. The unicast connection is used for transmission of an uplink media stream from the source terminal device to the PTT management server. The multicast connection is used for transmission of a downlink media stream from the PTT management server to the destination terminal device.

At Step 43, the source terminal device encodes audio and/or video and/or data into a media stream, and transmits it to the PTT management server via the unicast connection.

At Step 44, the PTT management server transmits the received media stream to the destination terminal device via the multicast connection.

At Step 45, the destination terminal device decodes the received media stream and presents it to the user.

According to the steps as described above, the source terminal device can make a PTT communication with the destination terminal device in order to perform transmission of audio and/or video and/or data.

Meanwhile, the method for PTT communication implementation by the PTT system according to the present invention further comprises the following steps.

At Step 46, the source terminal device transmits to the PTT management server a request message for call termination when the user is in the status of PTT communication. After the status is updated by the PTT management server, the source terminal device removes the established unicast connection and multicast connection and terminates the PTT communication.

Herein, the Step 41 comprises the following sub-steps in detail.

At Step 411, the user transmits to the call control module an instruction for initiating a PTT communication through the PTT initiation module, and requests for the initiation of the PTT communication.

At Step 412, the call control module transmits a call request to the call management module of the PTT management server after receiving the instruction for initiating the PTT communication.

The Step 42 comprises the following sub-steps in detail.

At Step 421, the call management module obtains information of the user group in which the terminal initiating the call request is located, from the user group and presence management module after receiving the call request.

At Step 422, the call management module judges whether or not there is a user transmitting information or speaking in the user group. If yes, it returns a message on failure of call request establishment to the call control module, and terminates the process. Otherwise, it returns to the call control module a message on success of call request establishment.

At Step 423, the call management module sets up the unicast connection for transmission of the uplink media stream from the source terminal device to the PTT management server.

At Step 424, the call management module informs the multicast management module of initiation of communication, and transmits information on the online user group in the user groups to the multicast management module.

At Step 425, the multicast management module sets up the multicast connection for transmission of the downlink media stream from the PTT management server to the online destination terminal device in the user groups;

The Step 46 comprises the following sub-steps in detail.

At Step 461, in the status of PTT communication, the terminal device transmits to the call control module a request for call termination via the PTT initiation module;

At Step 462, the call control module forwards the request for call termination to the call management module.

At Step 463, the call management module informs the user group and presence management module of update of the status, and informs the multicast management module of removal of the foregoing unicast connection and multicast connection.

At Step 464, the user group and presence management module updates the status, and the multicast management module removes the foregoing unicast connection and multicast connection. The PTT communication is terminated.

The above only gives the preferred embodiments of the present invention. Those ordinary skilled in the art should appreciate that any improvements and changes to the present invention are possible without departing from the principle of the present invention, which are regarded within the protection range of the present invention.

1. A PTT system comprising:
a plurality of terminal devices; and
a PTT management server interacting via a connection network, wherein the PTT management server is configured to set up a unicast connection between the PTT management server and a source terminal device of the plurality of terminal devices, and a multicast connection between the PTT management server and a destination terminal device of the plurality of terminal devices according to a call request from the source terminal device, and configured to receive an uplink media stream and transmit a downlink media stream, wherein the unicast connection is used for transmission of the uplink media stream from the source terminal device to the PTT management server, and wherein the multicast connection is used for transmission of the downlink media stream from the PTT management server to the destination terminal device.

2. The system according to claim 1, wherein the PTT management server comprises:
a presence management module configured to set a user group, to obtain and record presence information of the plurality of terminal devices, and to provide information of the user group and the presence information of the plurality of terminal devices;
a call management module configured to set up the unicast connection according to the call request from the source terminal device;
a multicast management module configured to set up the multicast connection according to the information of the user group and the presence information of the plurality of terminal devices; and
a media stream forwarding module configured to receive the uplink media stream from the unicast connection, and to transmit the received uplink media stream to the destination terminal device via the multicast connection.

3. The system according to claim 1, wherein each of the plurality of terminal devices comprises:
an access module configured to access the connection network;
a call control module configured to transmit a call request to the PTT management server, and to inform a media stream processing module to process the media stream after receiving a message on success of call request establishment;
a PTT initiation module configured to connect with the call control module; and
a media stream processing module configured to obtain the uplink media stream, to transmit the uplink media stream to the PTT management server via the unicast connection, and to receive the downlink media stream via the multicast connection.

4. The system according to claim 1, wherein the uplink media stream and the downlink media stream are each media streams for at least one of audio, video and data.

5. The system according to claim 1, wherein the connection network is of a type selected from the group consisting of WiFi, Wimax, UWB, 3G wireless and B3G wireless.

6. A method for implementing a PTT communication by a PTT system, the method comprising:
transmitting a call request to a PTT management server via a source terminal device;
setting up a unicast connection between the PTT management server and the source terminal device and a multicast connection between the PTT management server and a destination terminal device according to the call request from the source terminal device using the PTT management server;
transmitting an uplink media stream from the source terminal device to the PTT management server via the unicast connection; and
transmitting the received uplink media stream from the PTT management server to the destination terminal device via the multicast connection.

7. The method according to claim 6, wherein the step of setting up a unicast connection between the PTT management server and a source terminal device and a multicast connection between the PTT management server and a destination terminal device according to a call request from the source terminal device using the PTT management server comprises:
obtaining information of a user group in which the source terminal device initiating the call request is located using the PTT management server, after receiving the call request;
judging, using the PTT management server, whether or not there is a user sending information or speaking in the user group; and
if it is judged that there is a user sending information or speaking in the user group yes, performing the steps of:
returning to the source terminal device a message on failure of call request establishment and
terminating the process;
otherwise, performing the steps of:
returning from the PTT management server to the source terminal device a message on success of call request establishment; and
setting up the unicast connection between the PTT management server and the source terminal device and the multicast connection between the PTT management server and the destination terminal device.

8. The method according to claim 6, further comprising:
transmitting from the source terminal device to the PTT management server a call termination request message;
updating status with the PTT management server; removing the unicast connection and the multicast connections; and terminating the PTT communication.

9. The method according to claim 6, further comprising:
decoding the received downlink media stream using the destination terminal device; and
presenting the received and decoded downlink media stream to a user.

10. The method according to claim 6, wherein the uplink media stream streams at least one of audio, video and data.

11. A PTT management server comprising:
a user group and presence management module configured to set a user group, to obtain and record presence information of a plurality of terminal devices, and to provide information of the user group and the presence information of the plurality of terminal devices;
a call management module configured to set up an unicast connection according to a call request from a source terminal device of the plurality of terminal devices;
a multicast management module configured to set up a multicast connection according to the information of the user group and the presence information of the terminal device; and
a media stream forwarding module configured to receive an uplink media stream from the unicast connection, and to transmit the received uplink media stream to an online destination terminal device of the plurality of terminal devices via the multicast connection.

12. The PTT management server according to claim 11, wherein the uplink media stream is a media stream for at least one of audio, video and data.

13. A terminal device[[,]] comprising:
an access module configured to access to a connection network;
a media stream processing module configured to obtain an uplink media stream, to transmit the uplink media stream to the PTT management server via the unicast connection, and to receive a downlink media stream via a multicast connection;
a call control module configured to transmit a call request to a PTT management server, and to inform a media stream processing module to process the media stream after receiving a message on success of call request establishment; and
a PTT initiation module configured to connect with the call control module.

14. The terminal device according to claim 13, wherein the uplink media stream is a media stream for at least one of audio, video and data.

15. The terminal device according to claim 13, wherein the terminal device is a mobile terminal device.
